(19) United States
(12) Patent Application Publication
(10) Pub. No.: US 2020/0200365 A1
(43) Pub. Date: Jun. 25, 2020

(54) SPOT ADJUSTMENT SUBASSEMBLY FOR PROJECTION LAMP

(71) Applicants: Wanjiong Lin, Ningbo (CN); Self Electronics Co., Ltd., Ningbo (CN); Self electronics USA Corporation, Norcross, GA (US)

(72) Inventor: Sheng Zhang, Ningbo (CN)

(73) Assignees: Wanjiong Lin; Self Electronics Co., Ltd.; Self electronics USA Corp.

(21) Appl. No.: 16/721,482

(22) Filed: Dec. 19, 2019

(30) Foreign Application Priority Data
Dec. 25, 2018 (CN) 201811596193.6

(51) Int. Cl. F21V 14/08; F21V 11/18

(52) U.S. Cl. CPC F21V 14/08; F21V 11/186

(57) ABSTRACT

The invention discloses a spot adjustment subassembly for projection lamp, comprising a light shielding plate located at an light exit end of the light source assembly to block light, and a positioning member for limiting a deflection of the light shielding plate, the positioning member is disposed on the light exit end surface of the light source assembly or on the light incident end surface of the lens imaging assembly, abuts the light shielding plate and applies pressure to the light shielding plate toward the direction of the light incident end surface of the lens imaging assembly or the light exit end surface of the light source assembly. The invention has the advantages of improving the adjustment range of light spot, changing imaging shape and clear imaging.

### RELATED APPLICATION

This application claims priority to a Chinese Patent Application No. CN 201811596193.6, filed on Dec. 25, 2018.

### FIELD OF THE TECHNOLOGY

The present invention relates to optical field, with particular emphasis on a spot adjustment subassembly for projection lamp.

### BACKGROUND OF THE INVENTION

The projection lamp is often installed around the ceiling, in the upper part of the furniture, in the wall, etc., and the light is directly directed on the furniture to make it look good. In order to highlight objects, the projection lamp often needs to have the function of emitting light of specific shapes, which is mainly realized by the spot adjustment device.

For example, the Chinese invention patent CN106195930A, named as “A Spot Adjustment Assembly for Projection Lamps and a Zoom Projection Lamp”, disclose a spot adjustment assembly, which includes a middle clamping plate and a lower clamping plate stacked up and down, and the light shielding plate is located under the middle clamping plate, the light shielding plate is provided with a guiding column, which is rotated connected with the middle clamping plate or the lower clamping plate and can be slideably arranged in the first through groove on the middle clamping plate. The shape and size of the spot are changed by changing the shielding area of the light shielding plate to the light path through hole by the rotation and sliding setting of the guiding column.

Although the patent can realize the spot adjustment, the position and the orientation of the first through groove are limited, which limits the free movement range of the light shielding plate, thereby limiting the range of the spot adjustment, and the spot adjustment assembly has many parts and a complicated structure; At the same time, the light shielding plate is divided into two groups, which are spaced apart by the middle clamping plate, which easily causes the spot formed by one of the light shielding plates to be unclear, resulting in blurring of the image.

### BRIEF SUMMARY OF THE INVENTION

In view of the above problems, it is an object of the present invention to provide a spot adjustment subassembly for projection lamp having a simple structure, a large range of spot adjustment, and a variety of deformations.

It is still another object of the present invention to provide a spot adjustment subassembly for projection lamp having a clear spot image and excellent illumination effect.

in particular, a spot adjustment subassembly for projection lamp, comprising: a light shielding plate located at an light exit end of the light source assembly to block light, and a positioning member for limiting a deflection of the light shielding plate, characterized in that:

the positioning member is disposed on the light exit end surface of the light source assembly or on the light incident end surface of the lens imaging assembly, abuts the light shielding plate and applies pressure to the light shielding plate toward the direction of the light incident end surface of the lens imaging assembly or the light exit end surface of the light source assembly.

Advantageously, the light shielding plate has an even number, two as one group, which are sequentially stacked between the light source assembly and the lens imaging assembly, and the light shielding plates in each group are oppositely disposed and in the circumferential direction.

Advantageously, the number of the positioning members is equivalent to the number of the light shielding plates, and is evenly distributed around the light exit end face of the light source assembly or the light incident end face of the lens imaging assembly.

Advantageously, the light shielding plate has two pairs, one of which is stacked on the other pair and perpendicular to each other, and the positioning member has four, evenly distributed in the circumferential direction and respectively abutted the four light shielding plates.

Advantageously, the positioning member is a spring ball plunger which is fixed in a hole on the light exit end surface of the light source assembly or the light incident end surface of the lens imaging assembly.

Advantageously, the spring ball plunger includes a cylindrical cavity, a spring in a compressed state at an upper end of the cylindrical cavity, and a ball disposed in a free end of the spring and realizing point contact with the light shielding plate.

Advantageously, the ball is made of a steel material.

A projection lamp is characterized by the use of a spot adjustment subassembly as described above.

Compared with the prior art, the invention has the advantages that the positioning member is disposed on the light exit end surface of the light source assembly or the light incident end surface of the lens imaging assembly, and the positioning member is abutted against the light shielding plate and pressure is applied to the light shielding plate to restrict any rotation thereof. The combination can effectively reduce the limitation of the moving direction and range of the light shielding plate, and it is convenient to adjust the specific shape of the light spot according to the need; the stacking arrangement of the light shielding plate can effectively overcome the problem that the splint was set between the light shielding plate and the light shielding plate in the past, and the splint increases the distance between the light shielding plate above the splint and the light source, resulting in blurred imaging.

### BRIEF DESCRIPTION OF THE DRAWINGS

FIG. 1 is a schematic structural view of a projection lamp of the present application.

FIG.2 is an exploded view of FIG.1.

FIG. 3 is a partial cross-sectional view of FIG.1.

### DETAILED DESCRIPTION OF THE INVENTION

the present application is illustrated by way of the following detailed description based on of the accompanying drawings. It should be noted that illustration to the embodiment in this application is not intended to limit the invention. The embodiments of the present invention are described in detail below, and the examples of the embodiments are illustrated in the drawings, wherein the same or similar reference numerals are used to refer to the same or similar elements or elements having the same or similar functions. The embodiments described below with reference to the accompanying drawings are intended to be illustrative of the invention and are not to be construed as limiting.

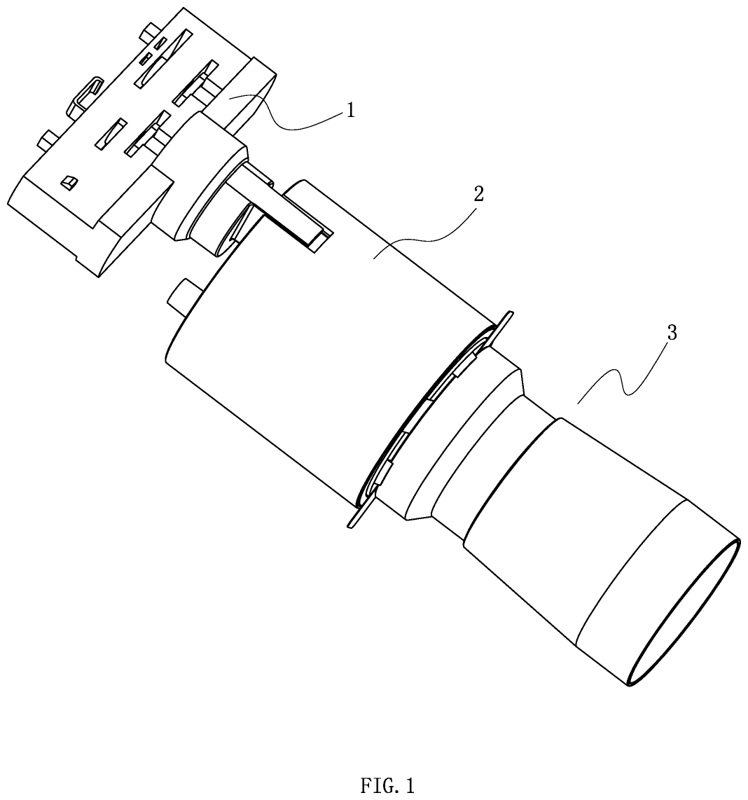

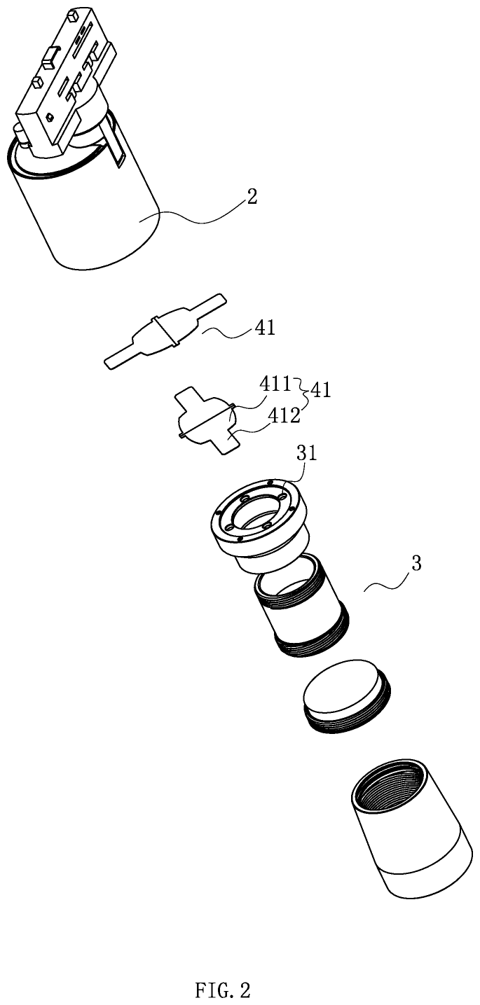

A preferred schematic diagram of the projection lamp of the present application is shown in FIG.1 and FIG.2. The projection lamp comprises a track control device 1, a light source assembly 2 connected to the track control device 1, and a lens imaging assembly 3 on the light exit end side of the light source assembly 2, but it should be mentioned that these devices belong to the structure generally possessed by the projection lamp. It is known to those skilled in the art, and the protection of the present application is not here, so it will not be elaborated here.

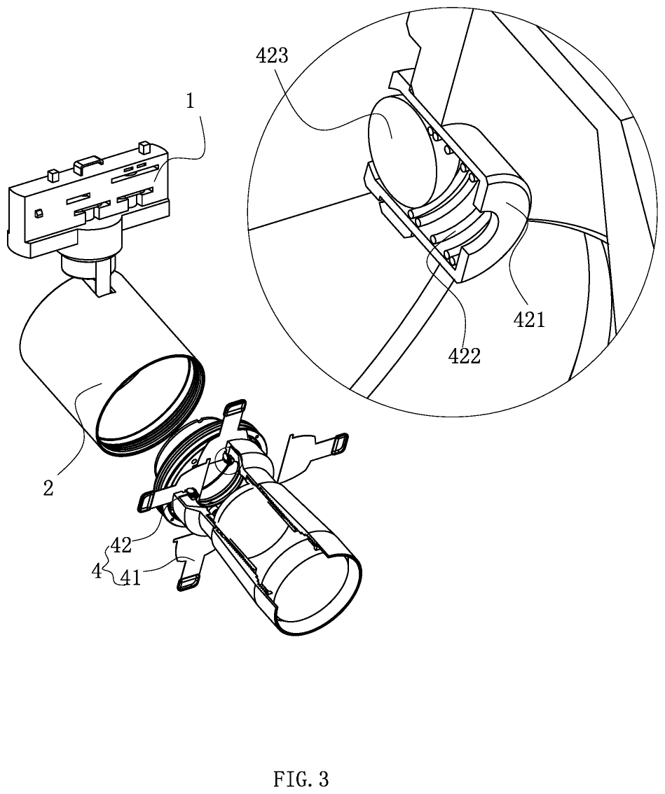

The present application focuses on the improvement of the spot adjustment device of the projection lamp, so the following is a detailed description. As shown in FIG. 1 and FIG. 3, the projection lamp of the present application further includes a spot adjustment subassembly 4 between the light source assembly 2 and the lens imaging assembly 3. The spot adjustment subassembly 4 includes a light shielding plate 41 located at the light exit end of the light source assembly 2 and used for shielding light, a positioning member 42 for limiting the movement of the light shielding plate 41. The positioning member 42 is disposed on the light exit end surface of the light source assembly 2 or the light incident end surface of the lens imaging assembly 3, abuts the light shielding plate 41 and applies pressure to the light shielding plate 41 toward the direction of the light incident end surface of the lens imaging assembly 3 or the light exit end surface of the light source assembly 2.

As is known, the light source assembly 2 has a light exit hole, the lens imaging assembly 3 has a light incident hole, the light shielding plate 41 is placed at the light exit end of the light source assembly 2 and covers the light exit hole, and the position of the light shielding plate 41 can be adjusted to change the area covered by the light exit hole, thus changing the amount of light emitted. Meanwhile, the shape of the aperture reserved by the light shielding plate 41 also determines the shape of the spot formed after the beam is emitted.

In other words, those skilled in the art know that the spot adjustment in the projection lamp mainly depends on adjusting the position of the light shielding plate, changing the size of the light exit hole and the shape of the light exit hole. In the case that the light exit hole is occluded, the essence of the spot adjustment ultimately depends on the gap formed between the light shielding plate and the light shielding plate, and the size and convenience of the movable adjustment range of the light shielding plate determine the variety of the spot deformation.

In the present application, the positioning member 42 is disposed on the light exit end surface of the light source assembly 2 or the light incident end surface of the lens imaging assembly 3. Compared with the previous spot adjustment assembly, it can ensure that the positioning member 42 and the light shielding plate 41 can realize contact with a contact surface as small as possible, thus providing as much freedom and range as possible for the movement adjustment of the light shielding plate 41. At the same time, the positioning member 42 also applies a pressure to the light shielding plate 41 toward the light incident end face direction of the lens imaging assembly 3 or the direction of the light exit end face of the light source assembly 2, which prevents the light shielding plate from excessively freely moving and holds it in the current position after the adjustment of the light shielding plate 41 is completed to play a fixed role, and the structure design is simpler. Specifically, in this embodiment, the positioning member is disposed on the light incident end surface of the lens imaging assembly 3, as shown in FIG. 3.

According to the optical imaging principle, the farther the light shielding plate is from the light source, the more blurred the imaging is, and the problem is more prominent when the distance between the light shielding plate and the light shielding plate is large. In order to overcome this problem, the light shielding plate 41 of the present application has an even number, two as one group, which are sequentially stacked between the light source assembly 2 and the lens imaging assembly 3, and the light shielding plates 41 in each group are oppositely disposed and in the circumferential direction. At the same time, the light shielding plate 41 is stacked, which avoids the problem of large spacing between different levels of light shielding plates, so that the user can easily realize the desired spot shape and prevent the foldover by adjusting only some of the light shielding plates as needed. Of course, the light shielding plate 41 may also be an odd number, such as one or three, two as one group, which are sequentially stacked between the light source assembly 2 and the lens imaging assembly 3, the single one is in a group and are stacked close to the lens imaging assembly 3.

The light shielding plate 41 includes a baffle 411. To facilitate the grip adjustment, the grip 412 is outwardly disposed on the rim of the baffle 411, as shown in FIG. 2, but it should be noted that the general shape of the light shielding plate is already known to those skilled in the art. It is well known that it may also include other structures depending on the actual situation, but the general shape is as shown in this embodiment, but it will not be elaborated here.

In order to facilitate the adjustment of each of the light shielding plates individually, preferably, the number of the positioning members 42 is equivalent to the number of the light shielding plates 41, and is evenly distributed around the light exit end face of the light source assembly 2 or the light incident end face of the lens imaging assembly 3. In the embodiment, the light shielding plate 41 has two pairs, and one pair is stacked on the other pair and perpendicular to each other. The positioning member 42 has four, which are evenly distributed on the light incident end surface of the lens imaging assembly 3 and respectively abutted the four light shielding plates. In each group of the light shielding plates, the wide side of one of the baffles 411 is aligned with the wide side of the other baffle 411, and when the baffles are placed on the light exit end face of the light source assembly 2, the light exit holes of the light source assembly 2 can be completely blocked.

When adjusting the light shielding plate 41, toggle the grip 412 to offset the light shielding plate 41 with the wide sides aligned, and the light shielding plate in each group can be adjusted as needed to finally form the desired aperture or slit. Light can be emitted from the aperture or slit and formed into a spot of the same shape as the aperture or slit.

The positioning member 42 is a spring ball plunger. Referring to FIG.3, the spring ball plunger is fixed in a hole 31 on the light incident end surface of the lens imaging assembly 3. The spring ball plunger includes a cylindrical cavity 421. The upper end of the cylindrical cavity 421 is fixed with a compressed spring 422. The lower end of the spring 422 is internally provided with a ball 423. The ball 423 is in contact with the light shielding plate 41 in a point-to-surface manner, so as to achieve contact with a minimum contact surface. And the elastic restorative force of spring 422 is used to exert pressure on the light shielding plate 41 through the ball 423 to position it.

The ball 423 is made of a steel material instead of a silica gel material, so that the resistance to the light shielding plate 41 is small, and the deflection movement of the light shielding plate 41 is facilitated, and the positioning is achieved by pressing the light shielding plate 41 to achieve the damping positioning, which can properly achieve the deflection fixation of the light shielding plate 41.

The above disclosure has been described by way of example and in terms of exemplary embodiment, and it is to be understood that the disclosure is not limited thereto. Rather, any modifications, equivalent alternatives or improvement etc. within the spirit of the invention are encompassed within the scope of the invention as set forth in the appended claims.

What is claimed is:

1. A spot adjustment subassembly for projection lamp, comprising: a light shielding plate (41) located at an light exit end of the light source assembly (2) to block light, and a positioning member (42) for limiting a deflection of the light shielding plate (41), characterized in that:
the positioning member (42) is disposed on the light exit end surface of the light source assembly (2) or on the light incident end surface of the lens imaging assembly (3), abuts the light shielding plate (41) and applies pressure to the light shielding plate toward the direction of the light incident end surface of the lens imaging assembly (3) or the light exit end surface of the light source assembly (2).

2. The spot adjustment subassembly for projection lamp as claimed in claim 1, wherein the light shielding plate (41) has an even number, two as one group, which are sequentially stacked between the light source assembly (2) and the lens imaging assembly (3), and the light shielding plates (41) in each group are oppositely disposed and in the circumferential direction.

3. The spot adjustment subassembly for projection lamp as claimed in claim 1, wherein the light shielding plate (41) has an odd number, two as one group, which are sequentially stacked between the light source assembly (2) and the lens imaging assembly (3), and the light shielding plates (41) in each group are oppositely disposed and in the circumferential direction, the last light shielding plate (41) forms a group and is stacked close to the lens imaging assembly (3).

4. The spot adjustment subassembly for projection lamp as claimed in claim 2, wherein the number of the positioning members (42) is equivalent to the number of the light shielding plates (41), and is evenly distributed around the light exit end face of the light source assembly (2) or the light incident end face of the lens imaging assembly (3).

5. The spot adjustment subassembly for projection lamp as claimed in claim 3, wherein the number of the positioning members (42) is equivalent to the number of the light shielding plates (41), and is evenly distributed around the light exit end face of the light source assembly (2) or the light incident end face of the lens imaging assembly (3).

6. The spot adjustment subassembly for projection lamp as claimed in claim 1, wherein the light shielding plate (41) has two pairs, one of which is stacked on the other pair and perpendicular to each other, and the positioning member (42) has four, evenly distributed in the circumferential direction and respectively abutted the four light shielding plates (41).

7. The spot adjustment subassembly for projection lamp as claimed in claim 1, wherein the positioning member (42) is a spring ball plunger which is fixed in a hole (31) on the light exit end surface of the light source assembly (2) or the light incident end surface of the lens imaging assembly (3).

8. The spot adjustment subassembly for projection lamp as claimed in claim 7, wherein the spring ball plunger includes a cylindrical cavity (421), a spring (422) in a compressed state at an upper end of the cylindrical cavity (421), and a ball (423) disposed in a free end of the spring (422) and realizing point contact with the light shielding plate (41).

9. The spot adjustment subassembly for projection lamp as claimed in claim 8, wherein the ball (423) is made of a steel material.
